(19) United States
(12) Patent Application Publication
(10) Pub. No.: US 2016/0130413 A1
(43) Pub. Date: May 12, 2016

(54) THERMOFORMABLE POLYLACTIC ACID

(71) Applicant: SOLEGEAR BIOPLASTICS INC., Vancouver (CA)

(72) Inventors: Toby Reid, Vancouver (CA); Michel Labonte, Montreal (CA)

(21) Appl. No.: 14/893,407

(22) PCT Filed: May 23, 2014
(86) PCT No.: PCT/CA2014/050483

§ 371 Date: Nov. 23, 2015

Related U.S. Application Data
(60) Provisional application No. 61/826,832, filed on May 23, 2013.

(51) Int. Cl. C08J 5/18; E05D 1/02; B29C 51/08

(52) U.S. Cl. CPC C08J 5/18; B29C 51/082; E05D 1/02; C08J 2367/04; C08J 2433/00; C08J 2451/00; B29K 2067/046

(57) ABSTRACT

The present disclosure provides an article manufactured from PLA, such as a packaging, comprising a hinge. The present disclosure provides a film comprising PLA and impact modifier. The present disclosure provides a PLA material having haze as measure by ASTM D1003 of about 10% or less, about 8% or less, about 6% or less, about 5% or less. The present disclosure provides a PLA material having an impact resistance as measured by ASTM D-5420 of about 2 inches or greater, about 3 inches or greater, about 3.5 inches or greater, about 4 inches or greater, about 4.5 inches or greater, about 5 inches or greater, about 0.5 inches or greater. The present disclosure provides a PLA material having a fold endurance as tested by TAPPI method 511-08 of about 100 cycles or greater, about 125 cycles or greater, about 150 cycles or greater.

### FIELD

This present disclosure relates to biodegradable materials and, in particular, to polylactic acids. The present disclosure further relates to devices, processes, methods and uses involving polylactic acid.

### BACKGROUND

Environmental concerns have led to a desire to ensure products are ‘biodegradable’. Many commonly used plastics show little or no biodegradability. Plastics in general have a decomposition rate of 50 to 1000 years depending on their base polymer, composition and geometry. One of the most critical parameters in the development of new plastics is biodegradability of plastic polymers under composting conditions. Previous research has indicated that several natural-based polymers, including polylactic acid (PLA), could be formulated for numerous industrial applications.

PLA polymers have been synthesized for more than 150 years. PLA can be manufactured in a variety of forms from readily biodegradable to durable with a long lifespan. Fermentation processes have allowed for increased production of much larger volumes. Typically, the intermediate, lactic acid, is manufactured through the fermentation of sugars, starches, molasses, or the like with the help of lactic acid bacteria and/or certain fungi. The structure (L- or D-lactides) is dependent upon the selection of fermentation bacteria, and accordingly to the biodegradability properties of the final the plastic. Polylactide and its copolymers range from quickly to not very biodegradable, depending on composition. Industrial compost facilities typically offer the conditions that are necessary for degradation hydrolysis at more than 58° C. PLA is quite stable under normal circumstances but decomposes readily by the action of microbes and enzymes, and is converted into lactic acid, carbon dioxide, and water.

PLA is an aliphatic polyester and, depending on crystallinity and additives. PLA is odor-free and exhibits considerable resistance to fats and oils. However, pure PLA's glass transition temperature is relatively low (approximately 60° C.) and it deteriorates rapidly in moist conditions. PLA softens drastically (approximately 1/100 in elastic modulus) at Glass Transition Temperature (Tg). Softening of polymers creates tackiness and thus problems in processing/mold releasability. PLA is generally a brittle material and can have poor impact resistance PLA. Use of impact modifiers can improve the impact resistance, but can also lower the clarity of the material. Certain thermoformed products, such as packaging, benefit from having good clarity.

Due to PLA's brittleness, it can be difficult to create a hinge that is resilient enough to survive usage. Resilient hinges can be important in packaging applications as they allow for the creation of plastic boxes and other types of packaging materials that require a greater than 90 degree angle for opening. While PLA has been used in hinged packaging, current materials do not tend to have sufficient fatigue resistance for hinged products to survive multiple opening and closing.

PLA's utility is thus somewhat limited by certain of its properties.

### SUMMARY

The present disclosure provides an article manufactured from PLA, such as a packaging, comprising a hinge.

The present disclosure provides a PLA material having haze as measure by ASTM D1003 of about 10% or less, about 8% or less, about 6% or less, about 5% or less.

The present disclosure provides a PLA material having an impact resistance as measured by ASTM D-5420 of about 2 inches or greater, about 3 inches or greater, about 3.5 inches or greater, about 4 inches or greater, about 4.5 inches or greater, about 5 inches or greater, about 5.5 inches or greater.

The present disclosure provides a PLA material having a fold endurance as tested by TAPPI method 511-08 of about 100 cycles or greater, about 125 cycles or greater, about 150 cycles or greater.

The present disclosure provides a composition comprising PLA and an impact modifier. In certain embodiments the impact modifier is an acrylic impact modifier such as, for example, a acrylic core-shell particle.

The present disclosure provides a process for the production of a PLA composition.

The present disclosure provides a biodegradable PLA composition.

As used herein, “hinge” refers to a flexure bearing usually made by thinning an elongated portion of the thermoformed material. This type of hinge is sometimes referred to as a ‘living hinge’. A living hinge in plastic thermoformed container is generally a thinned and/or shaped section of an article that allows the container to be opened and closed. A living hinge may, for example, connect two separated sections of a packaging such as the cover and the container of the article. The present hinge can be a coined corner or section of a sheet for producing a box or a container. The present hinge may be an injected plastic part that has the same geometry as the thermoformed part, but the wall thickness section is more critical for efficiency such as, for example, caps for shampoo bottles.

As used herein, “a” or “an” means “one or more”.

This summary does not necessarily describe all features of the invention. Other aspects, features and advantages of the invention will be apparent to those of ordinary skill in the art upon review of the following description of specific embodiments of the invention.

### BRIEF DESCRIPTION OF THE DRAWINGS

FIG. 1 shows the Striker/Specimen/Support Plate Configuration for Geometries GB and GC (Geometry GC Shown) for testing according to ASTM D5420;

FIG. 2 shows a thermoformed PLA article (+10% impact modifier) with a coined hinge;

FIG. 3 shows a thermoformed PLA article (+10% impact modifier) with a micro-perforated hinge;

FIG. 4 shows a thermoformed PLA clamshell article (+5% impact modifier) with a “living” hinge;

FIG. 5 shows the results of a Fold endurance test done with TAPPI 511-08.

FIG. 6 shows 50× magnification of a 450 μm thick PLA film with particles of impact modifier dispersed throughout.

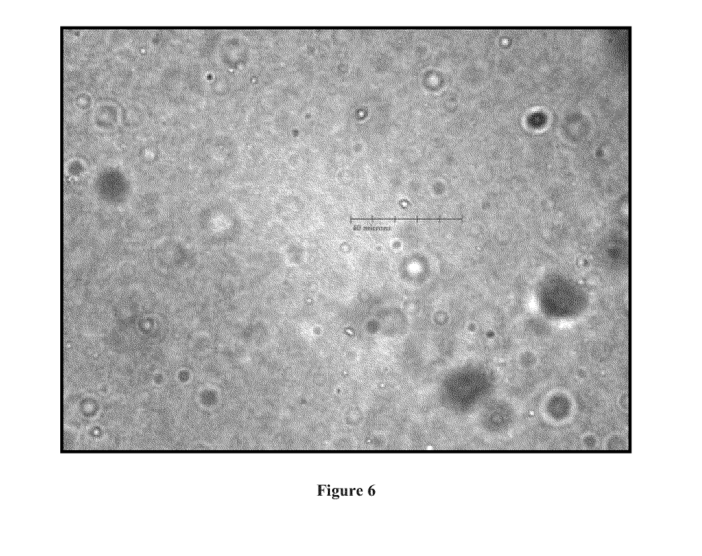

### DETAILED

The present disclosure provides a thermoformed or a diecut article manufactured from

PLA sheet, such as a packaging, comprising a flexure bearing-type hinge. The present hinge may be any suitable type. For example, the present hinge may be thermoformed, coined, scored, micro-perforated, or the like.

Due to, for example, its biodegradability profile manufacturing packaging from PLA would be desirable for a variety of articles. For example, many electronic devices are packaged in clamshell-type packaging made from, for example, polyethylene terephthalate or polypropylene. It would be advantageous from an environmental perspective to replace such material with PLA.

In general, neat PLA does not have sufficiently high fatigue resistance to form a hinge that is micro-perforated, coined or thermoformed that will survive more than a handful of open/close cycles before failure. Additives, such as impact modifiers, have been used to improve the performance of PLA. However, the addition of such materials has led to the resultant films being hazy.

While not wishing to be bound by theory it has been found that a PLA film comprising impact modifiers with acceptable haze and impact resistance can be produced if the modifier is well dispersed throughout the PLA matrix and/or the refractive index of the modifier is matched to that of the PLA.

The present disclosure provides thermoformed clamshell package made from PLA. The present disclosure provides thermoformed package made from PLA and extruded material that has been die cut and hinges have been created through coining, micro-perforation or thermoformed into a hinge as part of a general design.

The present disclosure provides PLA material having a thickness of about 1 mil or greater, about 5 mil or greater, about 10 or greater, about 13 mil or greater. The present disclosure provides PLA material having a thickness of about 50 mil or less, about 40 mil or less, about 30 mil or less, about 20 mil or less. In certain embodiments the present PLA material have a thickness of from 13 mil to 20 mil (0.13-0.020 inches). The present hinge may be of any suitable thickness such as, for example, from about 1 mil, about 3 mil, about 5 mil to about 30 mil, about 25 mil, about 20 mil. In certain embodiments the present hinge has a thickness of from 5 mil to 20 mil (0.05-0.020 inches).

The present disclosure provides a PLA material having haze as measured by ASTM D1003 of about 10% or less, about 8% or less, about 6% or less, about 5% or less.

The present disclosure provides a PLA material having an impact resistance as measured by ASTM D5420 of about 2 inches or greater, about 3 inches or greater, about 3.5 inches or greater, about 4 inches or greater, about 4.5 inches or greater, about 5 inches or greater, about 5.5 inches or greater.

The present disclosure provides a PLA material having fold endurance (as tested by TAPPI method 511-08) of about 100 cycles or greater, about 125 cycles or greater, about 150 cycles or greater.

The present disclosure provides a process for the production of a PLA composition. The present composition may be produced using any suitable method. For example, the compositions may be made via extrusion. Extrusion may involve preparing the PLA composition (e.g. grinding, moisture extraction), mixing impact modifier and/or other additives with the PLA, thermal compounding the mixture, and extruding. In contrast with many prior art compositions, the present compositions may be effectively extruded with a single screw extruder.

The present disclosure optionally provides a biodegradable PLA composition. Biodegradable polymers are those wherein the organic polymers molecules present in the composition break down into harmless, environmentally acceptable, chemicals such as water, carbon dioxide and sometimes methane. This may occur, for example, through an anaerobic process under certain compost conditions. The decomposition of polymers under compost conditions is usually achieved in the presence of soil, moisture, oxygen and enzymes or microorganisms. The American Society for Testing and Materials (ASTM) has established ASTM D-6400 entitled “Standard Specification for Compostable Plastics”. The compositions herein meet or exceed the requirements of this method. Other ASTM methods of interest in assessing the present disclosure include ASTM D-6002, ASTM D-6868, ASTM D-5511, and ASTM D-5526. Preferably the polymers of the present disclosure have greater than 50% disintegration within 28 days under anaerobic conditions and, in further embodiments, greater than 60%, or greater than 80% disintegration in 28 days under such conditions (accelerated landfill conditions). Anaerobic biodegradation is the disintegration of organic material in the absence of oxygen to yield methane gas, carbon dioxide, hydrogen sulphide, ammonia, hydrogen, water and a compost product suitable as a soil conditioner. It occurs as a consequence of a series of metabolic interactions among various groups of microorganisms in the anaerobic medium (sludge). The total solids concentrations in the test sludge are over 20% (35, 45, and 60%) and the pH is between 7.5 and 8.5. The test takes place at a mesophilic temperature (35±2° C.) with mixed inoculums derived from anaerobic digesters operating only on pretreated household waste (ASTM D-5526).

Any suitable polylactic acid (PLA) may be used herein. The terms “polylactic acid”, “polylactide” and “PLA” are used interchangeably to include homopolymers and copolymers of lactic acid and lactide based on polymer characterization of the polymers being formed from a specific monomer or the polymers being comprised of the smallest repeating monomer units. Polylactide is a dimeric ester of lactic acid and can be formed to contain small repeating monomer units of lactic acid (actually residues of lactic acid) or be manufactured by polymerization of a lactide monomer, resulting in polylactide being referred to both as a lactic acid residue containing polymer and as a lactide residue containing polymer. It should be understood, however, that the terms “polylactic acid”, “polylactide”, and “PLA” are not intended to be limiting with respect to the manner in which the polymer is formed.

Suitable lactic acid and lactide polymers include those homopolymers and copolymers of lactic acid and/or lactide which have a weight average molecular weight generally ranging from about 10,000 g/mol to about 600,000 g/mol, from about 30,000 g/mol to about 400,000 g/mol, or from about 50,000 g/mol to about 200,000 g/mol. Commercially available polylactic acid polymers which may be useful herein include a variety of polylactic acids that are available from the Chronopol Incorporation located in Golden, Colo., and the polylactides sold under the tradename EcoPLA®. Examples of suitable commercially available polylactic acid are NATUREWORKS® from Cargill Dow and LACEA® from Mitsui Chemical. Modified polylactic acid and different stereo configurations may also be used, such as poly D-lactic acid, poly L-lactic acid, poly D,L-lactic acid, and combinations thereof.

The present PLA may have a refractive index of about 1.4 or greater, about 1.41 or greater, about 1.42 or greater, about 1.43 or greater. The present PLA may have a refractive index of about 1.55 or less, about 1.54 or less, about 1.53 or less, about 1.52 or less, about 1.5 or less. Refractive indices may be assessed using a refractometer (ASTM D542).

The present compositions may comprise an impact modifier. Preferably the impact modifier has an average particle size of about 5 um or less. For example, the present impact modifier may have an average particle size of from about 2 um to about 5 um.

Any suitable impact modifier may be used such as, for example, core shell acrylic elastomers. The present impact modifier may be selected from, for example, Sukano im633 (Sukano), PARALOID BPM-515 (Dow), Biostrength B280 (Arkema), or the like. In certain embodiments the present compositions comprise from about 0.1% to about 20%, from about 1% to about 10%, from about 2% to about 8%, by weight, of impact modifier.

The present impact modifier may have a refractive index of about 1.4 or greater, about 1.41 or greater, about 1.42 or greater, about 1.43 or greater. The present modifier may have a refractive index of about 1.55 or less, about 1.54 or less, about 1.53 or less, about 1.52 or less, about 1.5 or less

In certain embodiments of the present composition the refractive index of the PLA and the refractive index of the impact modifier differ by about 15% or less, about 10% or less, about 8% or less, about 5% or less.

The present compositions may comprise a plasticizer. Any suitable plasticizers may be used such as, for example, triethyl citrate. In certain embodiments the present compositions comprise from about 0.1% to about 20%, from about 0.4% to about 10%, from about 0.6% to about 8%, from about 0.8% to about 5%, from about 1% to about 4%, by weight, of plasticizer.

The present compositions may comprise a variety of optional ingredients. Based on the intent of this disclosure to develop a fully biodegradable plastic, it is preferred that any additive also be biodegradable. Optional materials may be used, for example, as processing aids to modify the processability and/or to modify physical properties such as elasticity, tensile strength and modulus of the final product. Other benefits include, but are not limited to, stability including oxidative stability, brightness, color, flexibility, resiliency, workability, processing aids, viscosity modifiers, and odor control. These optional ingredients may be present in any suitable quantity but general comprise less than about 70%, from about 0.1% to about 50%, or from about 0.1% to about 40%, by weight, of the composition.

Examples of optional ingredients include, but are not limited to, gum arabic, bentonite, salts, slip agents, crystallization accelerators or retarders, odor masking agents, cross-linking agents, emulsifiers, surfactants, cyclodextrins, lubricants, other processing aids, optical brighteners, antioxidants, flame retardants, dyes, pigments, fillers, proteins and their alkali salts, waxes, tackifying resins, extenders, chitin, chitosan, and mixtures thereof.

Suitable fillers include, but are not limited to, clays, silica, mica, wollastonite, calcium hydroxide, calcium carbonate, sodium carbonate, magnesium carbonate, barium sulfate, magnesium sulfate, kaolin, calcium oxide, magnesium oxide, aluminum hydroxide, talc, titanium dioxide, cellulose fibers, chitin, chitosan powders, organosilicone powders, nylon powders, polyester powders, polypropylene powders, starches, and mixtures thereof. When used, the amount of filler is generally from about 0.1% to about 60% by weight of the composition.

It is preferred that the moisture content of the PLA composition be about 1% or less by weight of the PLA composition. For example, about 0.8% or less, about 0.6% or less, about 0.4% or less, about 0.2% or less, about 0.1% or less. The requisite moisture content may be achieved in any suitable manner. For example, the PLA composition may be dried under a vacuum.

The compositions herein may be used to form a molded or extruded article. As used herein, a “molded or extruded article” is an object that is formed using molding or extrusion techniques such as injection molding, blow molding, compression molding or extrusion of pipes, tubes, profiles, cables, or films. Molded or extruded articles may be solid objects such as, for example, toys, or hollow objects such as, for example, bottles, containers, tampon applicators, applicators for insertion of medications into bodily orifices, medical equipment for single use, surgical equipment, or the like. See Encyclopedia of Polymer Science and Engineering, Vol. 8, pp. 102-138, John Wiley and Sons, New York, 1987 for a description of injection, compression, and blow molding. See Hensen, F., Plastic Extrusion Technology, p 43-100 for a description of extrusion processes.

It is contemplated that the different parts of the present description may be combined in any suitable manner. For instance, the present examples, methods, aspects, embodiments or the like may be suitably implemented or combined with any other embodiment, method, example or aspect of the invention.

Unless defined otherwise, all technical and scientific terms used herein have the same meaning as is commonly understood by one of ordinary skill in the art to which this invention belongs. Unless otherwise specified, all patents, applications, published applications and other publications referred to herein are incorporated by reference in their entirety. If a definition set forth in this section is contrary to or otherwise inconsistent with a definition set forth in the patents, applications, published applications and other publications that are herein incorporated by reference, the definition set forth in this section prevails over the definition that is incorporated herein by reference. Citation of references herein is not to be construed nor considered as an admission that such references are prior art to the present invention.

Use of examples in the specification, including examples of terms, is for illustrative purposes only and is not intended to limit the scope and meaning of the embodiments of the invention herein. Numeric ranges are inclusive of the numbers defining the range. In the specification, the word “comprising” is used as an open-ended term, substantially equivalent to the phrase “including, but not limited to,” and the word “comprises” has a corresponding meaning.

The invention includes all embodiments, modifications and variations substantially as hereinbefore described and with reference to the examples and figures. It will be apparent to persons skilled in the art that a number of variations and modifications can be made without departing from the scope of the invention as defined in the claims. Examples of such modifications include the substitution of known equivalents for any aspect of the invention in order to achieve the same result in substantially the same way.

### EXAMPLES

### Formulating

STEP 1—GRINDING: PLA granules (base polymer) were obtained from Natureworks®. These were ground to reduce their size for better mixing. Flakes of 0.1-1 mm were produced through a standard grinder at a rate of 200 gr/10 min.

This is a batch process and several batches may be produced in the same manner.

STEP 2—MOISTURE EXTRACTION (DRYING/DEGASSING): The ground batches of PLA were placed in a vacuum oven (100 Torr) at 60° C. for 18-24 hrs. PLA moisture content was <0.01%. The additive(s) may be dried at the same time.

STEP 3—MIXING: The desired additives (4-5% impact modifier, 2% triethyl citrate (liquid)) and PLA were mechanically mixed for an hour on a roller mixer which is rotating at a frequency of 1.5 Hz for homogeneity.

This is a batch process and several batches may be produced in the same manner.

STEP 4—THERMAL COMPOUNDING: The mechanically mixed batches (PLA and additives) were fed into a single screw extruder with the following zone temperatures:

Zone 1 (feed)=310° F.-356° F. (154.4° C.-180° C.)

Zone 2 (barrel)=350° F.-392° F. (176.6° C.-200 ° C.)

Zone 3 (die)=392° F.-419° F. (200° C.-215° C.)

The feed rate varies with the screw RPM. L/D ration (screw)=20.

STEP 5—EXTRUSION: The compounded formulations was extruded at a screw RPM of 20 and the strands of the compound with diameter of 1-2 mm are cut into 50 cm strands.

STEP 6—PELLETIZING: The strands of compounded formulation were fed into a multi-blade pelletizer at a rate of 0.5-15 m/min. The resultant pellets have a length of 0.5-3 mm.

### Thermoforming and Injection Molding

Thermoforming is a process where plastic sheets, in roll or in cut sheet, are bring to rubbery state by heating the sheet. The sheet is held in a rigid frame to avoid slipping of sheet during molding. At the right temperature, the sheet is lowered to be in contact with a mold (or the mold is raised to be in contact) with or without the use of a plug (called plug assisted molding); the sheet is stretched by the use of a vacuum (or a pressure) and forced to take shape of the mold. The mold can be either positive (male) or negative (female), rarely matched molds. For single use thin wall container, cycle time is generally very low; therefore the output is quite important by the use of multi cavities mold.

Injection molding is a process where plastic pellets are melted in a plasticising unit (screw and cylinder) and melted allowing the plastic to flow and fill the cavity or the multiple cavities of the injection mold. The injection mold is made of hardened steel, may contain multiple cavities, and designed with a circulating circuit for cooling the final part. Injection of single containers is usually multi-cavities.

In single use and rigid packaging applications, containers are made either by injection or thermoforming. In either case, the containers are thin walled usually with thickness less than 0.6 mm depending on sides. Containers may be composed of 2 different pieces, i.e. the container and the cap or with a contained having an integrated cover by the use of a living hinge. In order to obtain good mechanical resistance and fatigue resistance, the hinge have to be well adapted to the behavior of the plastic itself; polymer chain alignment perpendicular to the hinge and well designed to keep in consideration of ductility and plasticity of the material.

### Results

A formulation was made containing Ingeo PLA 2003D, 2% tri-ethyl citrate, and 5% impact modified (Sukano im 633). Three specimens were tested for haze in accordance with ASTM D-1003. The results are shown in Table 1.

TABLE 1
Haze-ASTM D 1003

| Specimen | % Haze |
|---|---|
| 1 | 4.8 |
| 2 | 5.1 |
| 3 | 4.9 |
| Average | 4.9 |

Formulations having a haze of about 10% or less are usually considered acceptably transparent for certain packaging uses.

Formulations were prepared containing PLA, TEC, and impact modifier as described in Table 2.

TABLE 2
Formulations
Formulations

Ingeo PLA 2003D (Control)
Ingeo PLA 2003D containing TEC
(from a master batch at 10% concentration obtained in Twin Screw
industrial compounding)
Ingeo PLA 2003D with Impact modifier PARALOID BPM-515 (Dow)
(powder form and research masterbatch form)
Ingeo PLA 2003D with Impact modifier Sukano im633 (Sukano)
(industrial Masterbatch)

The formulations were tested for their impact resistance in accordance with ASTM D-5430. Standard Test Method for Impact Resistance of Flat, Rigid Plastic Specimen by Means of a Striker Impacted by a Falling Weight (Gardner Impact)

Impact weight used (modification from original test): 550 g (1.21 lb)

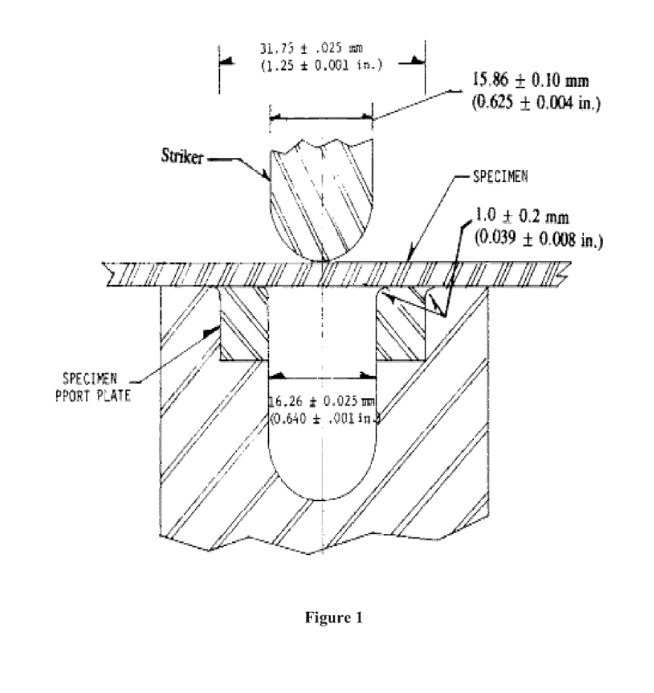

Striker geometry: GB (see FIG. 1)

Preparation of samples: Dry blend of PLA 2003D and TEC at 10% in a masterbatch PLA 2003D and addition of two different impact modifiers (Paraloid BPM 515, and Sukano IM 633) as well according to below formulations.

Samples formation: Die casted extruded sheet, thickness of 18-20 mils

Results are the average height (inch) at which 50% of samples presented a failure.

Obtained by the “stair method”. The results are shown in Table 3.

TABLE 3
Gardner Impact results

| | Value | Increase | |
|---|---|---|---|
| Identification | (in) | (%) | Remarks |
| 2003D neat | 1.35 | REF | Control Sample |
| 2003D 2% TEC | 3.08 | 228% | Important variation |
| | | | in results from 160% |
| | | | to 228% increase |
| | | | probably due to TEC |
| | | | dispersion |
| 2003D + 2% TEC + | 4.3 | 319% | |
| 4% IM BPM 515 | (0.41 J) | | |
| 2003D + 3% TEC + | 5.0 | 370% | |
| 5% IMB PM 515 | (0.58 J) | | |
| 2003D + 2% TEC + | 5.5 | 407% | |
| 4% im Sukano 633 | (0.67 J) | | |
| 2003D + 2% TEC + | 6.0 | 444% | |
| 5% im Sukano 633 | (0.8 J) | | |
| 2003D + 2% TEC + | 6.0 | 444% | |
| 6% im Sukano 633 | (0.8 J) | | |

The formulations showed acceptable impact resistance.

### Fatigue Resistance

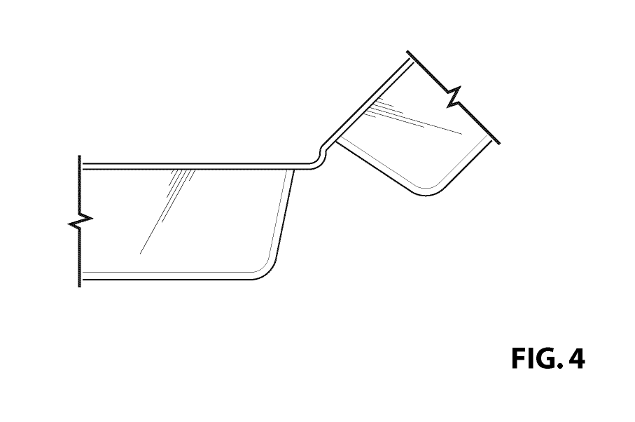

3 different types of hinges with PLA were examined; a coined hinge, a micro perforated hinge and a thin-moulded part that is not coined or scored. The third type is a thin wall that is part of the thermoformed mould, used for the box as show at FIG. 4.

### Coined PLA

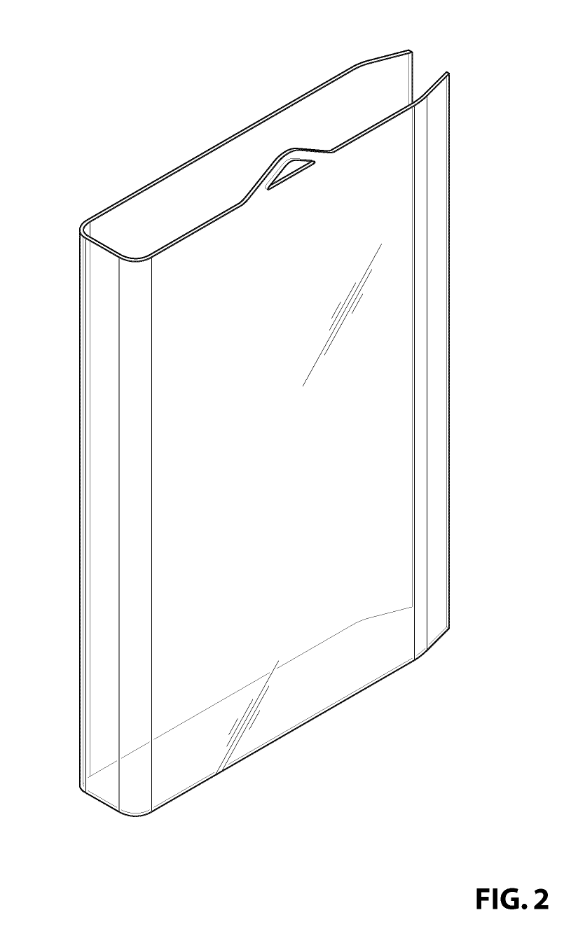

Sheets of neat PLA shattered during die cutting. When 10% of Sukano impact modifier was added a coined hinge was able to be processed (see FIG. 2).

### Micro-Perforated PLA

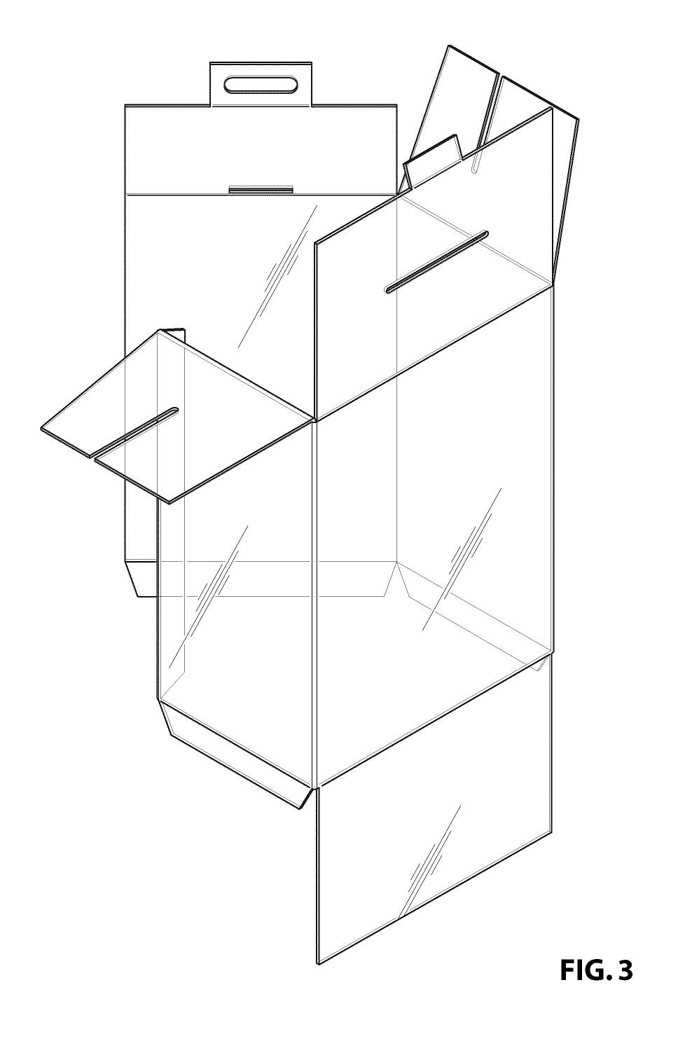

A micro-perforated hinge was formed using a formulation with 10% impact modifier. The result is shown in FIG. 3.

### Scored Material Hinge

A PLA formulation with 5% impact modifier and 2% TEC was moulded into a clamshell container as shown in FIG. 4.

The hinge has high fatigue resistance (>100 cycles). Living hinges are usually injected molded in polypropylene. In that case, sizing, dimensions of hinges and gate location are critical to a high number of cycles resistance.

PLA thermoformed clamshell designs typically need some type of modification with either a very specific geometry's hinge or with a score at the center of the hinge point in order to bend. The clamshell shown in FIG. 4 did not to need scoring or coining in the hinge in order to enable bending. Some embodiments express a thermoformed PLA hinge, yet it usually with a loss of clarity of the packaging. In addition, the hinge showed good fatigue resistance while maintaining clarity

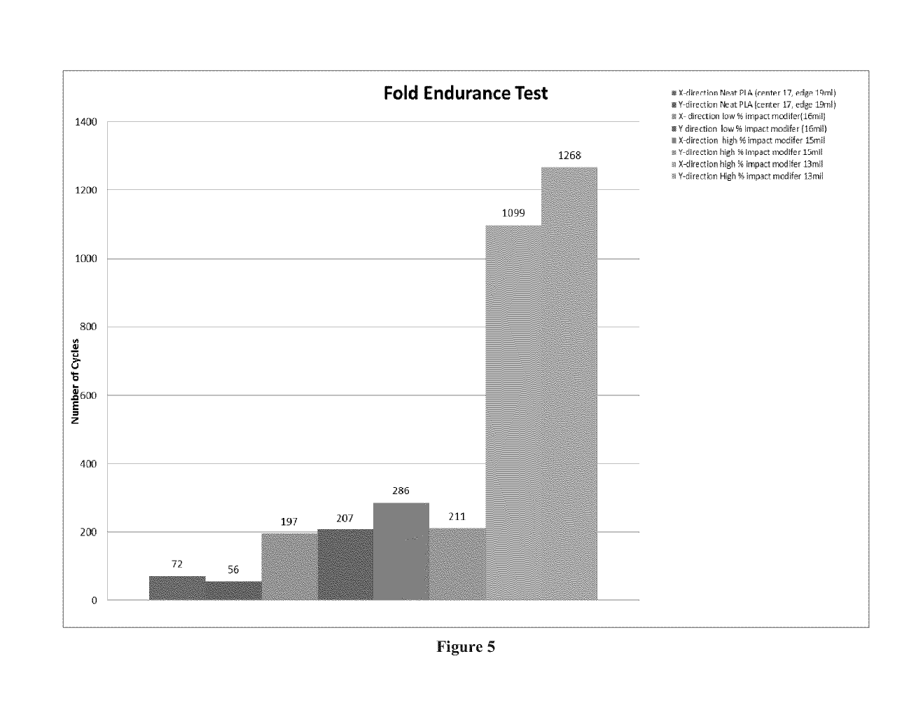

A fold endurance test was run on the samples with TAPPI T 511 om-08. This test gives information around the material properties of the plastic related to the fold endurance, but not specifically the true hinge. Film thickness is important in this test and ideally this test would have been run at the same thickness but there was some variability in the samples tested. The results are shown in FIG. 5.

1. A film comprising polylactic acid and impact modifier wherein said film has a haze, as measured by ASTM D-1003, of about 10% or less and has impact resistance as measured by ASTM D-5420 of about 2 inches or greater.

2. The film according to claim 1 wherein said film has a haze of about 8% or less, about 6% or less, about 5% or less.

3. The film according to claim 1 wherein said film has impact resistance of about 3 inches or greater, about 3.5 inches or greater, about 4 inches or greater, about 4.5 inches or greater, about 5 inches or greater, about 5.5 inches or greater.

4. The film according to claim 1 wherein the film has a thickness of from about 20 mil to about 13 mil.

5. The film according to claim 1 wherein the polylactic acid and impact modifier have a refractive index of about between about 1.4 and about 1.55.

6. The film according to claim 1 wherein the refractive indices of the polylactic acid and impact modifier differ by about 10% or less.

7. The film according to claim 1 wherein the impact modifier is selected from acrylic impact modifiers.

8. The film according to claim 1 wherein the impact modifier is selected from core-shell acrylic elastomers.

9. The film according to claim 1 wherein the moisture content of the polylactic acid is about 1%, by weight, or less.

10. The film according to claim 1 wherein the film is ASTM D-6400 compliant.

11. The film according to claim 1 wherein the film disintegrates by about 50% or more within 28 days under the conditions specified in ASTM D-5526.

12. The film according to claim 1 wherein the film has a fold endurance as tested by TAPPI method 511-08 of about 100 cycles or greater, about 125 cycles or greater, about 150 cycles or greater.

13. A method of forming an article comprising:
(a) providing a film according to claim 1;
(b) heating said composition; and
(c) thermoforming said article.

14. The method of claim 13 wherein the article comprises a hinge.

15. The method of claim 14 wherein the hinge has a fold endurance as tested by TAPPI method 511-08 of about 100 cycles or greater, about 125 cycles or greater, about 150 cycles or greater.

16. An article comprising the film of claim 1 wherein said article comprises a hinge, said hinge having a fold endurance as tested by TAPPI method 511-08 of about 100 cycles or greater, about 125 cycles or greater, about 150 cycles or greater.

17. Use of a film according to claim 1 for producing an article.

18. The use of claim 17 wherein the article comprises a hinge.

19. The use of claim 18 wherein the hinge has a fold endurance as tested by TAPPI method 511-08 of about 100 cycles or greater, about 125 cycles or greater, about 150 cycles or greater.

20. A method of producing a molded article comprising a hinge said method comprising:
(a) providing a film according to claim 1;
(b) heating said film to a temperature above its melt temperature;
(c) placing the heated film into a mold; and
(d) cooling to below melt temperature.
